(19) United States
(12) Patent Application Publication
(10) Pub. No.: US 2006/0216011 A1
(43) Pub. Date: Sep. 28, 2006

(54) Thermal infrared camera tracking system utilizing receive signal strength

(76) Inventor: Katareya Godehn, Chapel Hill, NC (US)

Correspondence Address: Katareya Godehn, 104 Eagle Rock Court, Chapel Hill, NC, 27516, US

(21) Appl. No.: 11/358,429

(22) Filed: Feb. 21, 2006

Related U.S. Application Data
(60) Provisional application No. 60/664,281, filed on Mar. 22, 2005.

(51) Int. Cl. G03B 17/00

(52) U.S. Cl. 396/58

(57) ABSTRACT

A thermal infrared camera tracking system utilizing receive signal strength is provided for firefighters and emergency service first responders, the system can include a plurality of portable units which can be individually tracked and located using information simultaneously displayed with the thermal infrared video image on the video display of the thermal infrared camera. The thermal infrared camera encompasses a RF transceiver for receiving wireless RF signals transmitted by one or more portable unit(s). The RF signal transmission of a portable unit is displayed as a unique identification (ID) name and when displayed on the video display is an indication an emergency condition. The user of the thermal infrared camera selects one identification (ID) name (if more than one identification (ID) name is displayed) and views visual indicators on the video display being indicators of the strength of the RF signal transmitted by the portable unit to track and locate the selected portable unit. The user of the thermal infrared camera upon selecting a identification (ID) name, views the visual indicators indicating a RSSI value to determine a direction to and distance from the selected portable unit.

### CROSS-REFERENCE TO RELATED U.S. APPLICATION

This application claims benefits, and claims priority to, U.S. Provisional Patent Application Ser. No. 60/664,281, filed on Mar. 22, 2005 by Katareya Godehn entitled “Thermal Infrared Camera with location and tracking utilizing receive signal strength”.

### BACKGROUND OF THE INVENTION

1. Field of the invention

The present invention generally relates tracking and location, and more particularly to enhancements for thermal infrared cameras, whereby a thermal infrared camera is capable of producing and displaying information as visual indicators used to track and locate a transmitting portable unit worn or carried by a user. The thermal infrared camera derives information from the RF signal transmitted by a portable unit, and displays the information as visual indicators on the video display which is used to track and locate the portable unit. The thermal infrared video image is displayed on the video display simultaneously with indicators of the general direction to the portable unit and general distance to the portable unit.

2. Description of the Prior Art

There are many occupations wherein workers require the use an thermal infrared camera to navigate and or perform search and rescue operations in hazardous environments having limited or no visibility. Use of thermal infrared cameras has proven to be particularly useful to firefighters when searching for victims or a firefighting co-worker that has become trapped and or injured within a burning structure and requires the assistance of a rescue team to exit the burning structure. For example, a firefighter would employ the use of a thermal infrared camera upon entry into a smoke fill environment to view the surrounding area, objects and or persons within a building or structure where radiating energy in the infrared spectrum range is located. Most notably thermal infrared cameras are used by firefighters to search and locate victims and or another firefighter requiring assistance to exit the interior of a burning structure. A thermal infrared camera allows a firefighter to view objects or persons located within the interior of a structure that would be otherwise obscured by the dense smoke created by the fire. Thermal infrared cameras are recognized in the art for providing a thermal infrared video image of objects radiating energy in the infrared range, allowing a firefighter or a firefighting rescue team the ability to navigate within in a smoke filled structure by viewing the thermal infrared video image on the video display.

However, there still exists a need in the art for additional features to improve a thermal infrared camera as a more effective search tool in used for locating a firefighter that has become trapped and or injured and is not capable of exiting the burning structure without assistance. A burning structure or building creates a dangerous environment having limited or no visibility due to smoke, and structural damage which occurs when a structure or building burns. The structural integrity of a burning building diminishes, creating a dangerous environment in the form of, e.g., falling debris from walls and or ceilings or possible total structural failure resulting in a collapse of the structure. For example, if a firefighter has been covered by fallen debris within a burning building, in this situation a thermal infrared camera used as a search tool to locate a firefighter is not normally capable of penetrating the debris covering the firefighter causing a situation where the firefighting rescue team may not be able locate the firefighter.

A burning building or structure limits visibility and creates a hazardous environment with a lethally toxic atmosphere. To accommodate firefighting operations within such a hazardous environment, a firefighter would wear self-contained breathing apparatus (SCBA) which supplies fresh air for a limited time duration. On occasion a firefighter wearing a SCBA may become trapped, lost, entangled, injured and or cover by debris within a burning structure making exiting the structure difficult or impossible before the firefighter's SCBA fresh air supply is exhausted. Under these circumstances, a firefighting rescue team would be sent into the structure normally with a thermal infrared camera in an attempt to locate and rescue a trapped, lost or injured firefighter, before the firefighter's SCBA fresh air supply is exhausted, or the firefighter is enveloped by the spreading fire. If a burning structure is relatively large and or the location of the firefighter within the structure in not known, the rescue team may spend an excessive amount of time searching the entire structure, room by room and or floor by floor in an effort to visibly locate a co-worker using a thermal infrared camera. This method of relying solely on a visual search method using a thermal infrared camera system is very time consuming and requires the rescue team to conduct an extensive search of the interior of the burning structure to locate the co-worker. Since, the SCBA worn by firefighters has a limited amount of fresh air within the air cylinder, and the fire can spread very rapidly, the time to locate and extract the firefighter from the burning structure is critical. Furthermore, a firefighter not wearing an SCBA may become trapped, injured and or covered by debris within the burning structure, a firefighter in this situation would certainly need to be almost immediately located and extracted from the structure.

Thermal infrared cameras currently used for search and rescue operations locate and rescue firefighters within a burning structure or building, distinguishes objects based on temperature differences between objects and the surrounding environment. The protective equipment worn by a firefighter is designed to protect the firefighter from high temperatures, however the protective equipment can become relatively close to the surrounding environment temperature causing a situation that would render a firefighter virtually undetectable by a thermal infrared camera.

Furthermore, location and tracking systems such as Global positioning system (GPS) and or RF systems using triangulation have also been proposed for locating firefighters within the structure at a fire scene. A GPS satellite signals necessary to for a GPS receiver to operate normally will not penetrate a building or is not accurate within a building or structure. Most RF systems using triangulation require antennas to be positioned outside of the structure to perform location. The location of a firefighter requiring assistance to exit the burning structure would be viewed on a display terminal which is located outside the burning structure. This method offers little assist to a firefighting rescue team which must operate and navigate within the interior of the burning structure. A firefighting rescue team performing a search and rescue operation to locate a firefighter within the structure at a fire scene, upon entering a burning structure would normally not be familiar with the interior and or general floor plan of the structure, falling debris from the deteriorating structure and the dense smoke created by the fire further hinders rescue operations and locating of a firefighting co-worker.

Therefore, as can be readily appreciated from the foregoing discussion, it would be advantageous for firefighters or first responders to have a thermal infrared camera system capable of displaying information to track and locate a firefighter. The information is displayed simultaneously with a thermal infrared video image to facilitate the locating a trapped and or injured firefighter within a hazardous environment. By displaying the information on the video display of the thermal infrared camera as visual indicators indicating a direction and distance to a firefighter requiring assistance to exit a burning structure, would facilitate the rescue of the firefighter by a rescue team especially, when the exact location of a firefighter is unknown and or the firefighter is covered by debris. Furthermore, under most circumstances the present invention would reduce the amount of time a rescue team would spend within the hazardous environment attempting to locate a co-worker, thereby reducing the risk of injury to team members.

### SUMMARY OF PRESENT INVENTION

Accordingly, it is the object of the present invention to provide enhancements to a thermal infrared camera when used as a tool for search and rescue. An emergency condition at the portable unit is indicated by displaying a unique identification (ID) name of a portable unit, and visual indicators indicating an receive signal strength indicator (RSSI) value of the RF signal transmitted by the portable unit. The visual indicators displayed on the video display are used to locate the portable unit worn carried or attached to an SCBA of a firefighter or first responder. The visual indicators and the identification (ID) name are simultaneously displayed with the thermal infrared video image on the video display. The present invention would under most circumstances fascinate the locating and rescue of firefighters within a hazardous environment especially when the exact location of a firefighter is unknown and or a firefighter has been covered by debris.

The present invention provides the user with visual indicators viewable on the video display of the thermal infrared camera to track and locate a firefighter wearing or carrying a portable unit. The visual indicators are viewed on the video display as a unique identification (ID) name and a receive signal strength indication (RSSI) value derived from RF signal transmitted by a portable unit. Furthermore, the present invention is capable of displaying more than one identification (ID) name(s) on the video display of a thermal infrared camera. A user of the present invention can select one specific portable unit to track which is identifiable by its unique identification (ID) name displayed on the video display of the thermal infrared camera. A user by selecting a identification (ID) name initializes displaying of the RSSI value as visual indicators corresponding directly to the identification (ID) name selected. The user by pointing the thermal infrared camera in different directions within the structure and observing the RSSI visual indicators for a maximum peak RSSI value, the user is capable of determining an approximate direction to a portable unit and an approximate distance to a transmitting portable unit. The visual indicators indicating the strength of the wireless RF signal and the identification (ID) name are simultaneously displayed on the video display with the thermal infrared video image. Furthermore, a rescue team using the present invention within a hazardous environment searching for a co-worker, would under most circumstances be required to spend less time within the hazardous environment, thus reducing the risk of injury to rescue team members.

### BRIEF DESCRIPTION OF THE DRAWING

FIG. 1 is a perspective view of a thermal infrared camera tracking system utilizing receive signal strength in accordance with the preferred embodiment of the present invention.

FIG. 2 is a electrical schematic block diagram of a thermal infrared camera tracking system utilizing receive signal strength in accordance with an embodiment of the present invention.

FIG. 3 is a perspective rear view illustration of the video display of the thermal infrared camera when receiving a wireless RF signal from a single portable unit in accordance with a preferred embodiment of the present invention.

FIG. 4 is a perspective rear view illustration of the video display of the thermal infrared camera when receiving wireless RF signals from multiple portable units in accordance with an embodiment of the present invention;

FIG. 5 is a perspective view of a thermal infrared camera receiving wireless RF signals from multiple portable units.

FIG. 6 is a electrical schematic block diagram of the portable unit used in a thermal camera tracking system utilizing receive signal strength in accordance with an embodiment of the present invention.

FIG. 7 is a front view perspective illustration of the portable unit used in a thermal camera tracking system utilizing receive signal strength in accordance with an embodiment of the present invention.

FIG. 8 is a side view perspective illustration of the portable unit used in a thermal infrared camera tracking system utilizing receive signal strength in accordance with an embodiment of the present invention.

### DETAIL DESCRIPTION OF THE PERFERRED EMBODIMENTS

Referring to the drawing, fields of applicability of the present invention will become evident from the detailed description and examples provided within the preferred embodiment(s). It should be noted that while indicative of the preferred embodiment(s), the description and examples are intended for the purposes of illustration only and are not intended to limit the scope of the present invention.

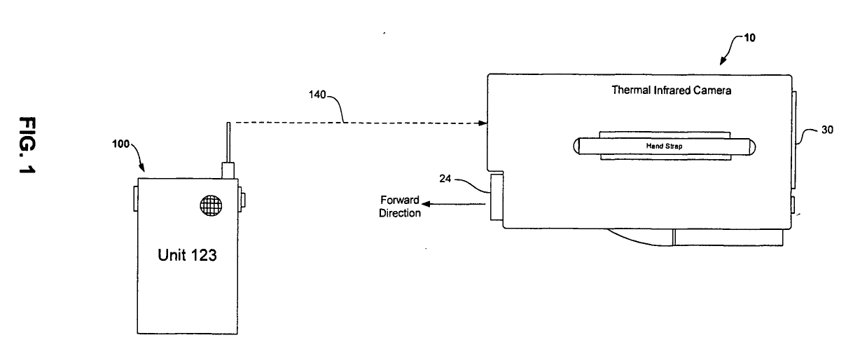

Now referring to FIG.1 is a perspective view of a thermal infrared camera tracking system utilizing receive signal strength with the preferred embodiment of the present invention. FIG. 1 illustrates a wireless RF signal 140 transmitted by a portable unit 100 being received at the thermal infrared camera 10. The thermal infrared camera 10 is equipped to receive, process and display information pertaining to a wireless RF signal 140 transmitted by the portable unit 100 which can be worn, carried or attached to an SCBA of a firefighter or first responder.

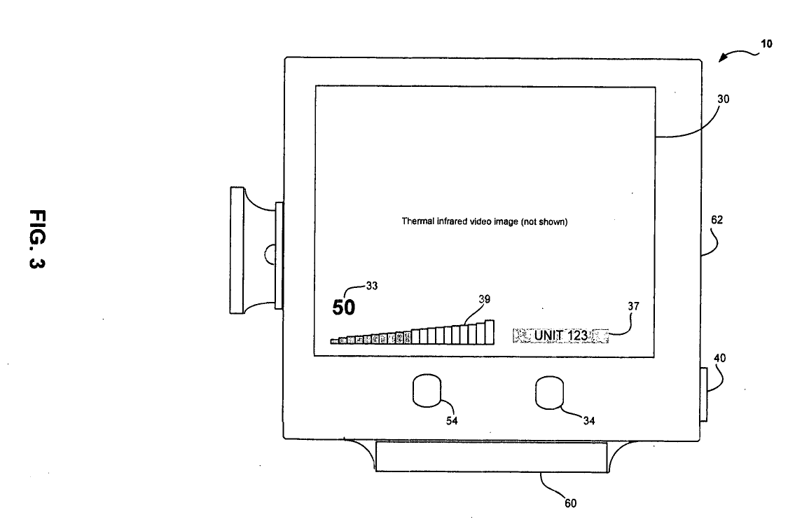

The wireless RF signal 140 transmitted by the portable unit 100 is a RF signal modulated with one or more data packets, the data packets transmitted contain an identification (ID) name unique to the portable unit 100. FIG.1 illustrates portable unit 100 having a unique identification (ID) name of “Unit 123”. The RF signal 140 is receive by the thermal infrared camera 10 which is equipped to receive the wireless RF signal 140 and derives information from the RF signal 140 which is displayed on the video display 30 in the form of a receive signal strength indicator (RSSI) value and an identification (ID) name derived from and directly related to the RF signal 140 transmitted by portable unit 100. Both the identification (ID) name and the RSSI value are displayed simultaneously with the thermal infrared video image on the video display 30. The RSSI derived from the RF signal 140 will indicate an increase in the RSSI value on video display 30 when the thermal infrared camera 10 is pointed in a forward direction towards the portable unit 100, being in the same direction as the thermal infrared camera core 24. A decrease in RSSI value will be indicated on display 30 when the thermal infrared camera 10 is pointed in a direction away from the transmitting portable unit 100. Furthermore, as distance between the thermal camera 10 and the portable unit 100 increases, the video display 30 will indicate a decrease in the RSSI value. Conversely, as distance between the thermal infrared camera 10 and the portable unit 100 decreases the video display 30 will indicate an increase in the RSSI value. In summary a user by observing the RSSI value indicated on the video display 30 as visual indicators, a user is capable of distinguishing an approximate direction to the portable unit 100 and approximate distance from the portable unit 100 by observing the RSSI value displayed on the video display 30 as visual indicators are further summarized and detail in FIG. 3. The user of the thermal infrared camera 10 keeps the thermal infrared camera 10 generally parallel with the ground and moves the thermal infrared camera 10 in a clockwise and counter clockwise motion (back and forth ) while viewing the RSSI value indicated on the display 30 as visual indicators. A user is capable of distinguishing a general direction to the portable unit 100 by observing the visual indicators on the video display in which a maximum peak RSSI value was indicated. The user will then move in the direction in which a maximum peak RSSI reading was obtained, and continue to pan the thermal infrared camera in a back and forth motion while observing the RSSI value as visual indicators on the video display 30. As the user continues to move in a direction towards the portable unit 100, the distance between the thermal infrared camera 10 and the portable unit 100 decreases the RSSI value will continue to increase until a maximum RSSI value is obtained, a maximum RSSI value being e.g., 100 percent full scale reading of the visual indicators on the video display 30 indicating the user with the thermal infrared camera is within 3-4 feet of the a transmitting portable unit 100.

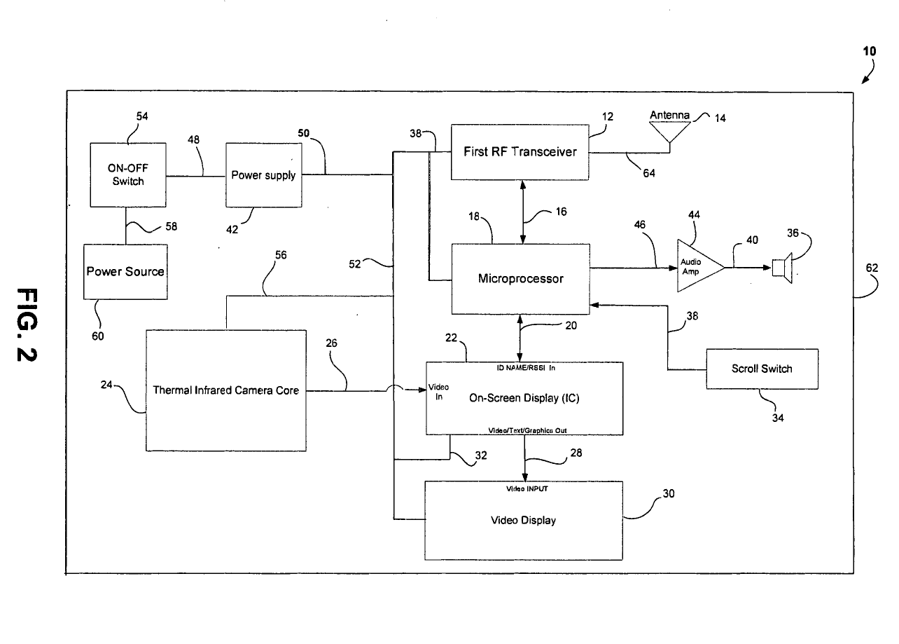

FIG. 2 is a electrical schematic block diagram of the thermal infrared camera tracking system utilizing receive signal strength in accordance with an embodiment of the present invention with reference to FIG. 1, and FIG. 3. Referring to FIG. 2 which illustrates the antenna 14 which internal to housing 62 of the thermal infrared camera 10. The antenna 14 preferably a directional antenna, example, panel, or flat patch antenna having a vertical beam width of 80 degrees or less and a horizontal beam width of 80 degrees or less, thus giving antenna 14 a greater RF receive signal gain when pointing in a direction towards the transmitting portable unit 100, illustrated in FIG. 1, versus the RF signals being received at the sides or rear directions of antenna 14. A directional antenna is known in the art of antenna design for having a greater transmit and or receive RF signal gain when pointing in the direction of a RF signal source, versus a RF signals received at the sides or rear of the antenna. Thus, the result of a directional antenna when used in the present invention and pointing the antenna in the same forward direction as the thermal infrared camera core 24, illustrated in FIG. 1, would provide an indication on the display 30 at the rear of the thermal camera 10 of the RSSI being stronger when the thermal infrared camera is pointed in the direction towards the transmitting portable unit 100, illustrated in FIG. 1.

The electrical schematic block diagram in FIG. 2 illustrates the antenna 14 being electrically coupled by electrical line 64 to the first RF transceiver 12. The first RF transceiver being either an, e.g., a Direct Sequence Spread Spectrum (DSSS) or Frequency Hopping Spread Spectrum (FHSS) RF transceiver operating at a frequency equal to or greater than 900 MHz capable of receiving the RF signal 140 being a RF carrier signal modulated with one or more data packets transmitted by the portable unit 100 illustrated in FIG. 1

The first RF transceiver 12 being but not limited to, e.g., a CC1020 RF transceiver, manufactured by ChipCon, which has a built-in receive signal strength indicator (RSSI) producing a digital RSSI value from the RF signal 140 transmitted by the portable unit 100 illustrated in FIG. 1. The first RF transceiver 12 produces a digital RSSI value being, e.g., (0-100), whereby a “0” value being a minimal digital RSSI value and a “100” being maximum digital RSSI value. The first RF transceiver 12 further derives an identification (ID) name from the data packets. The identification (ID) name is contained within the data packets of the RF signal 140 transmitted by the portable unit 100, illustrated in FIG. 1. FIG. 2 further illustrates the first RF transceiver 12 electrically coupled to a microprocessor 18 by serial port interface (SPI) data line 16 and is used for bidirectional communications. The first RF transceiver 12 transfers the digital RSSI value and identification (ID) name to microprocessor 18 by way of SPI data line 16.

FIG. 2 further illustrates the microprocessor 18 being electrically connected to an audio amplifier 44 by way of electrical line 46 for amplifying the output signal of microprocessor 18 used to produce audible sound. The amplifier 44 is connected by electrical line 40 to preferably a speaker or a piezo 36, which produces audible sounds in an ascending and descending manner ranging between 400 Hz-6 KHz. The sound produced are generally proportional the increase and decrease in the digital RSSI value received by the microprocessor 18 from the first RF transceiver 12. Microprocessor 18 processes the digital RSSI value and identification (ID) name producing a digital signal being American Standard Code for Information Interchange (ASCII) text containing the digital RSSI value and identification (ID) name. Microprocessor 18 transfers the ASCII text data by way of SPI data line 20 to an on-screen display integrated circuit (IC) 22. The on-screen display IC 22 being, e.g., a STV5730 or equivalent component which is used in numerous commercial applications where text and or graphics are required to be overlaid on a video picture.

A on-screen display IC is recognized in the art for performing the overlay of user defined text and graphics in real time onto a NTSC or PAL video source. As in prior art pertaining to thermal infrared cameras, normally the thermal infrared video signal generated by thermal infrared camera core 24 is sent directly to the video display 30 being an Liquid Crystal Display (LCD) or an Organic Light Emitting Diode (OLED) type video display for viewing a video signal. However, the present invention sends the thermal infrared video signal produced by the thermal infrared core 24, to the on-screen display IC 22 by way of the video input line 26 to be processed with the ASCII text data used for tracking and location produced by microprocessor 18. Both the thermal infrared video signal and the ASCII text data are processed by the on-screen display IC 22 which produces an output signal which is sent by video output line 28 to the video display 30. The output of the on-screen display IC 22 is viewed on the video display 30 which is illustrated in FIG. 3 with the thermal infrared video image (not shown) overlaid with the identification (ID) name 37 and visual indicator 33 and 39 representative of the digital RSSI value.

The thermal camera 10 having a battery power source 60 coupled by electrical line 58 to a preferably two-position ON-OFF switch 54, for coupling and uncoupling the battery power source 60 by way of electrical line 48 to the power supply 42 which regulates the battery power. The power supply 42 is electrically coupled by electrical lines 50 and 38 to the first RF transceiver 12 and microprocessor 18. The power supply 42 is coupled to the thermal infrared camera core 24 by way of electrical line 56, and to the on-screen display (IC) 22 by way of electrical line 32, and to the video display 30 by way of electrical line 52.

Now referring to FIG. 3 is a perspective rear view illustration of the video display of the thermal infrared camera when receiving a wireless RF transmission from a single portable unit in accordance with a preferred embodiment of the present invention with reference to FIG. 1 and FIG. 2. FIG. 3 illustrates a rear view of the thermal infrared camera 10 having a housing 62 retaining a video display 30, displaying the identification (ID) name 37 and visual indicator 33, and 39 as indicators of the RSSI value. The visual indicator 33 displays the RSSI value as a numeric value ranging from “0-100”. Example, a “0” indicates a low RSSI value and a “100” indicates a maximum RSSI value. The visual indicator 39 displays the RSSI value as a bar graph were a minimal RSSI value is indicated by no shading of the bars within the bar graph and a maximum RSSI value would be indicated with all bars in the bar graph shaded, visual indicator 39 shows a half scale RSSI value were only half of the bars are shaded and visual indicator 33 displays a “50” RSSI value. The visual indicator 33 and 39 indications will change proportional to the digital RSSI value derived by the first RF transceiver 12 previously summarized and detailed in FIG. 2. FIG. 3 illustrates the identification (ID) name 37 being “Unit 123” as the portable unit 100 illustrated in FIG. 1 to be tracked using the visual indicator 33 and 39. Furthermore, the identification (ID) name 37 when displayed on the video display 30 is indication an emergency condition and that a user wearing or carrying a portable unit is in need of assistance or rescue. Sound is produced from the speaker 40 that is generally proportional to the increase and decrease in the RSSI value indicated by the visual indicator 33, and 39. Switch 54 is used for coupling the battery power source 60 power ON/OFF as discussed previously in FIG. 2.

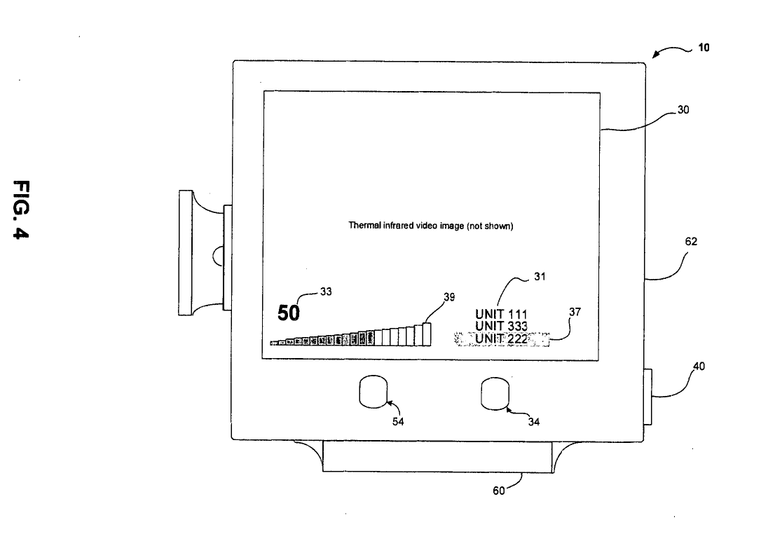

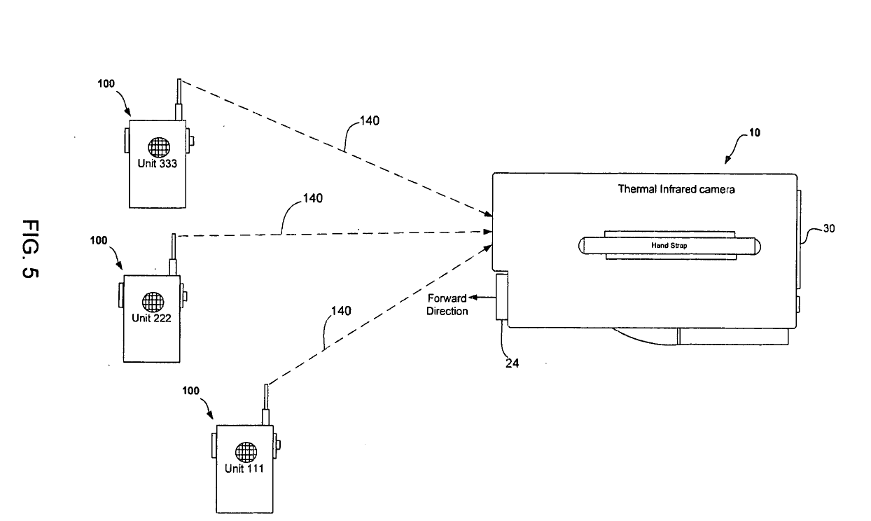

Referring to FIG. 4 which is a perspective rear view illustration of the video display of the thermal infrared camera when receiving wireless RF transmissions from multiple portable units in accordance with an embodiment of the present invention. FIG. 4 with reference to FIG. 2 and FIG. 5, illustrates the video display 30 located at the rear of the thermal infrared camera 10 retained by the housing 62. The video display 30, displaying the thermal infrared video image (not shown) overlaid with a list of identification (ID) name(s) 31, furthermore as previously stated anytime an identification (ID) name is displayed on the video display 30 is an indication of an emergency condition. FIG. 4 illustrates the capabilities receiving and displaying a list of identification (ID) nane(s) 31 on video display 30. The list of identification (ID) names 31 displayed on video display 30 are directly related to the RF signals at numeral 140 transmitted by the three portable units at numeral 100 illustrated in FIG. 5. Each portable unit 100, in FIG. 5 is capable of being programmed with a unique identification (ID) name by the user, the unique identification (ID) name “Unit 111”, “Unit 222” and “Unit 333” of the portable units at numeral 100 illustrated in FIG. 5. A unique identification (ID) name is necessary and required for distinguishing between RF signals at numeral 140 if more than one portable unit is transmitting and the RF signals indicated at numeral 140 of transmissions by multiple portable units 100 are received by the thermal infrared camera 10, illustrated in FIG. 5.

Illustrated in FIG. 4 is the video display 30, displaying the thermal infrared video image (not shown) overlaid with a list of multiple identification (ID) names 31 corresponding to the transmissions of three transmitting portables with identification (ID) names “Unit 111”, “Unit 222” and “Unit 333, at numeral 100, in FIG. 5. FIG. 4 illustrates the highlighted ID name 37 being the portable unit 100 with the identification (ID) name of “Unit 222” as the portable to be tracked and located using visual indicator 33, and 39. The visual indicator 33 and 39 are representative strength of the RF signal 140 transmitted by portable unit 100 having the unique ID name of “Unit 222”. The visual indicator 33 being numeric values and visual indicator 39 being bars graphs representative strength of the RF signal 140 transmitted by portable unit 100 with the ID name of “Unit 222” illustrated in FIG. 5.

The user by depressing and holding switch 34 for more than two seconds and releasing performs a transition to the next identification (ID) name in list of identification (ID) names 31 which would be “Unit 333” which will then be placed in the highlighted area on the video display 30 be tracked using the visual indicator 33, and 39 corresponding to the strength of the RF signal 140 transmitted by “Unit 333”. FIG. 4 illustrates a speaker 40 located on the housing 62, which produces an audible ascending and descending tone ranging between 400 Hz-6 KHz that is generally proportional the increase and decrease in the RSSI value indicated on visual indicator 33, and 39, the speaker 40 is an audible indicator of the RSSI value. The thermal infrared camera having an ON-OFF switch 54 for coupling and uncoupling the power source 60, previously discussed and detailed in FIG. 2.

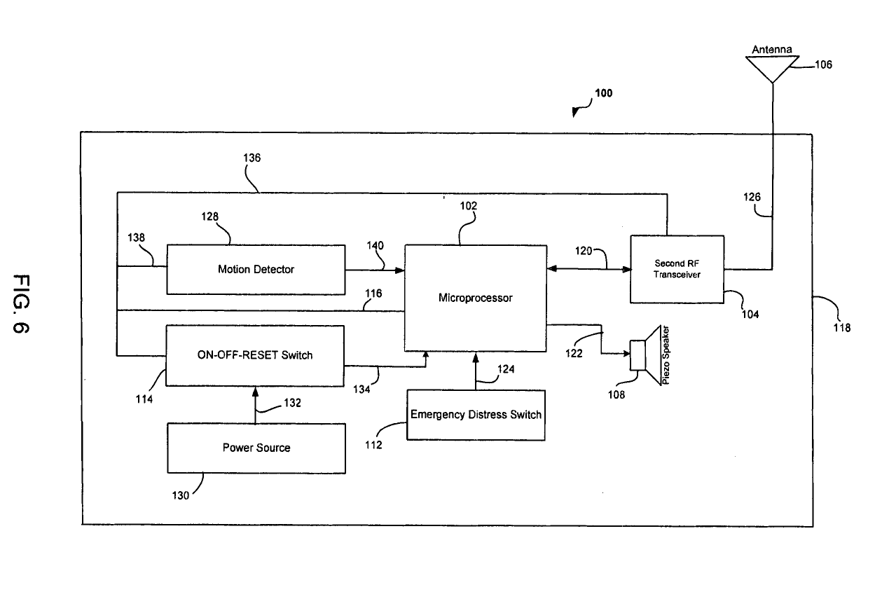

Referring to FIG. 6 is a electrical schematic block diagram of the portable unit used in a thermal infrared camera tracking system utilizing receive signal strength in accordance with an embodiment of the present invention. FIG. 6 illustrates the portable unit 100, having a housing 118 encompassing a microprocessor 102 which is capable of being programmed with an identification (ID) name which is user definable up to 32 characters or less. The identification (ID) name is capable of being programmed into the microprocessor 102 by the user and should be programmed as a unique identification (ID) name into each portable unit 100. The identification (ID) name is stored in the Read Only Memory (ROM) of microprocessor 102 which is connected by SPI data line 120 to a second RF transceiver 104. The second RF transceiver 104 is coupled by electrical line 126 to the antenna 106 which can be either an internal or external to the housing 118.

The second transceiver 104 being either a DSSS or FHSS RF transceiver, operating at a frequency equal to or greater than 900 MHz and capable of transmitting a wireless RF signal being a RF carrier signal modulated with one or more digital data packets. The digital data packets transmitted by second RF transceiver 104 contain the identification (ID) name that has been pre-programmed by the user into ROM of microprocessor 102. The microprocessor 102 transfers the identification (ID) name by way of electrical SPI data line 120 to the second RF transceiver 104. The second RF transceiver 104 transmits the identification (ID) name as data packets modulated on the RF carrier signal. Transmission of the identification (ID) name by the portable unit 100 is an indication of an emergency condition. Transmission of the identification (ID) name by portable unit 100 only occurs when the user depresses the emergency distress switch 112, or lack of motion of the motion detector 128 is not detected by the microprocessor 102 within predetermined time set forth by the software program on microprocessor 102.

The motion detector 128 being e.g., an accelerometer for detecting motion or lack of motion is encompassed within the housing 118 and is connected by electrical line 140 to microprocessor 102. If no motion of the motion detector 128 is detected by microprocessor 102, based on a predetermine time set in the software, microprocessor 102 will transfer via the SPI data line 120, the identification (ID) name to the second RF transceiver 104 for transmission. A speaker 108 connected by electrical line 122 to microprocessor 102, will produce an audible sound when the RF transceiver 104 is actively transmitting to alert the user of the transmitting condition. The microprocessor 102 is connected by electrical line 134 to the ON-OFF-RESET switch 114. The switch 114 is a combination momentary contact push-button which performs the reset function and a two position rotary contact which performs coupling of the power source 130. The momentary contact portion of switch 114 when depressed by the user, signals the microprocessor 102 by electrical line 134, to reset the software timer within the program running on microprocessor 102, stopping the RF transceiver 104 from transmitting. The ON-OFF function of switch 114 uses the rotary contact portion for coupling and uncoupling the battery power source 130 by electrical line 132. The switch 114 provides battery power by electrical line 116 to microprocessor 102, to the RF transceiver 104 by electrical line 136, and to the motion detector 128 by electrical line 138.

An emergency distress switch 112 being a momentary contact style electrical switch is connected by electrical line 124 to microprocessor 102. Depressing and releasing the emergency distress switch 112, will signal microprocessor 102 to immediately send the second RF transceiver 104 the identification (ID) name for transmission, and sound will be produced out of speaker 108, as an indication to the user the portable unit 100 is actively transmitting, the speaker 108 is electrically connected to microprocessor 102 by electrical line 122. The second RF transceiver 104 will transmit the identification (ID) name as a data packet at a rate of greater than one data packet every second, and will continue to transmit until the user depressed switch 114 to signal the microprocessor 102, to reset, or uncoupling of the battery power source 130 using the rotary switch portion of the switch 114.

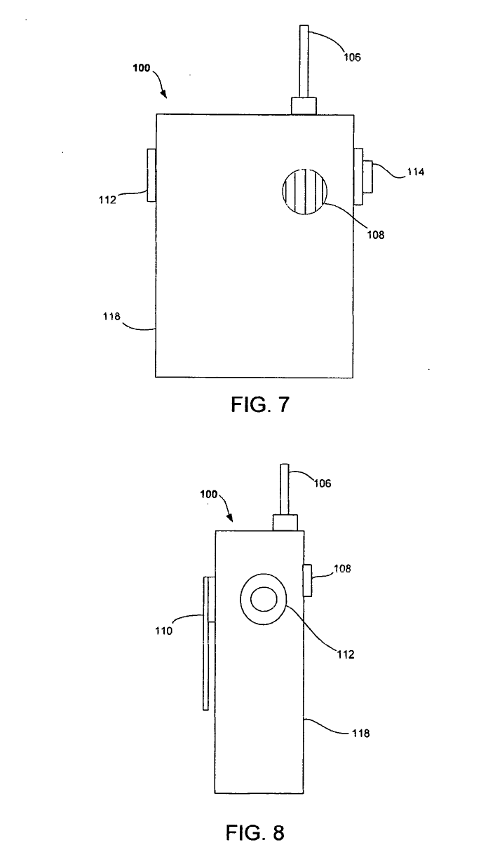

Referring to FIG. 7 a front view of the portable unit in accordance with one embodiment of the present invention. FIG. 7 illustrates a front view of the portable unit having a speaker 108 for producing sound to alert to the user that the portable unit 100 is actively transmitting. The portable unit 100 is equipped with an antenna 106 to increase the transmission range of the RF signal transmitted by the second RF transceiver when transmitting. As illustrated in FIG. 7 the portable unit having a switch 114 which is used as an ON-OFF-RESET and an emergency pushbutton switch 112, and an antenna preferably but not limited- to an external antenna 106 retained by housing 118.

FIG. 8 is a side view perspective illustration of the portable unit used in a thermal camera tracking system utilizing receive signal strength in accordance with one embodiment of the present invention. FIG. 8 illustrates the emergency distress switch 112 on the left drawing side for easy access, and the antenna 106 on top of and retained by the housing 118, and the speaker for producing sound. The belt clip 110 preferably molded as part of the housing 118 is used to attach the portable unit 100 to a belt, harness or waist belt of a self contained breathing apparatus (SCBA) worn by a first responder or firefighter.

What is claimed:

1. A thermal infrared camera tracking system, system comprising of:
(a) a thermal infrared camera, capable of receiving a wireless RF signal and having a housing; and
a first RF transceiver encompassed within said housing, said first RF transceiver coupled to an antenna for receiving said wireless RF signal being a RF carrier signal modulated with one or more data packets, said first RF transceiver derives a digital RSSI value from said wireless RF signal that is indicative of the strength of said wireless RF signal; and
a display displaying one or more visual indicators representative of the said digital RSSI value, said visual indicators are simultaneously displayed with a thermal infrared video image on said display.
(b) a portable unit, worn or carried, capable of transmitting a wireless RF signal and having a housing; and
a second RF transceiver encompassed within said housing, said second RF transceiver coupled to an antenna for transmitting said wireless RF signal being a RF carrier signal modulated with one or more data packets, said wireless RF signal transmitted by said portable unit is received at the said thermal infrared camera.

2. A thermal infrared camera in said claim 1, said visual indicators being one or more numeric values being representative of the digital RSSI value derived by the said first RF transceiver, said numeric values correspond to the wireless RF signal transmitted by a said portable unit, said numeric values are displayed simultaneously with said thermal infrared video image on said display.

3. A thermal infrared camera in said claim 1, said visual indicators further being one or more bar graphs being representative of the digital RSSI value derived by the said first RF transceiver, said bar graphs correspond to the wireless RF signal transmitted by said portable unit, and are displayed simultaneously with said thermal infrared video image on said display.

4. A thermal infrared camera in said claim 1, said visual indicators displayed being indicators of an approximate direction to the said portable unit when the said portable unit is actively transmitting.

5. A thermal infrared camera in said claim 1, said visual indicators displayed further being indicators of an approximate distance between said portable unit and said thermal infrared camera when the said portable unit is actively transmitting.

6. A thermal infrared camera in said claim 1, having a microprocessor coupled to the said first RF transceiver and further being coupled to a speaker which produces audible ascending and descending sounds generally proportional to an increase or decrease in the digital RSSI value indicated by the said visual indicators.

7. A thermal infrared camera tracking system, system comprising of:
(a) a thermal infrared camera, capable of receiving a wireless RF signal and having a housing; and
a first RF transceiver encompassed within said housing, said first RF transceiver coupled to an antenna for receiving said wireless RF signal being a RF carrier signal modulated with one or more data packets, said first RF transceiver derives a digital RSSI value from said wireless RF signal that is indicative of the strength of the said wireless RF signal, said first RF transceiver further derives an identification (ID) name from said data packets; and
a display displaying the said identification (ID) name simultaneously with a thermal infrared video image.
(b) a portable unit, capable of transmitting a wireless RF signal and having a housing; and
a second RF transceiver encompassed within said housing, said second RF transceiver coupled to an antenna for transmitting said wireless RF signal being a RF carrier signal modulated with one or more data packets, said data packets transmitted contain the identification (ID) name of said portable unit, said wireless RF signal transmitted by said portable unit is received at the said thermal infrared camera.

8. A portable unit in said claim 7, carried or worn or attached to a self contained breathing apparatus (SCBA) as a method of transport by a firefighter or an emergency services first responder.

9. A thermal infrared camera in said claim 7, said identification (ID) name displayed being one or more letter characters and or one or more numeric characters, said identification (ID) name displayed on said display corresponds to the wireless RF signal transmitted by the said portable unit.

10. A thermal infrared camera in said claim 1, said identification (ID) name displayed on said display is a unique identifier of said portable unit, said identification (ID) name is displayed simultaneously with the thermal infrared video image on said display.

11. A thermal infrared camera in said claim 10, said identification (ID) name when displayed on said display is an indication of an emergency condition by a said portable unit.

12. A thermal infrared camera in said claim 7, said display further displaying one or more visual indicators representative of the digital RSSI value derived by said first RF transceiver, said visual indicators displayed on said display correlate to the wireless RF signal transmitted by a said portable unit, said visual indicators are simultaneously displayed with a thermal infrared video image on said display.

13. A thermal infrared camera in said claim 12, said visual indicators being one or more bar graphs representative of the digital RSSI value derived by the first RF transceiver.

14. A thermal infrared camera in said claim 13, said bar graphs being an indicator indicating an approximate direction to a portable unit and an approximate distance between the thermal imaging camera and the portable unit when actively transmitting.

15. A thermal infrared camera in said claim 12, said visual indicators further being one or more numeric values representative of the digital RSSI value derived by the first RF transceiver.

16. A thermal infrared camera in said claim 15, said numeric values being an indicator indicating an approximate direction to a portable unit and an approximate distance between the thermal imaging camera and the portable unit when actively transmitting.
